(19) United States
(12) Patent Application Publication
(10) Pub. No.: US 2017/0193205 A1
(43) Pub. Date: Jul. 6, 2017

(54) INCREMENTALLY POLYMORPHING CODE FOR ENHANCED RESISTANCE TO REVERSE ENGINEERING

(71) Applicant: CYBER 2.0 (2015) LTD, Yavne (IL)

(72) Inventor: Erez KAPLAN HAELION, Rehovot (IL)

(21) Appl. No.: 15/396,717

(22) Filed: Jan. 2, 2017

Related U.S. Application Data
(60) Provisional application No. 62/273,499, filed on Dec. 31, 2015.

(51) Int. Cl. G06F 21/14

(52) U.S. Cl. CPC G06F 21/14

(57) ABSTRACT

A computer-implemented method, computerized apparatus and computer program product for enhanced resistance to reverse engineering of code using incremental polymorphism. Incremental modifications to a software resource of a computer program are received from a server and used for updating the resource from a current to an updated state in each of the computer program instances at a plurality of devices, whereby updating is performed in a synchronized manner and without the updated resource being transmitted via a communication channel. Processing performed by the computer program based on the updated resource results in different operation thereof than prior to the update, such that instances of the computer program obtained prior to the update without having the incremental modifications, or incremental modifications obtained without having the resource's current state, amount to invalid instances that operate differently from those instances in the plurality of devices, whereby reverse engineering is made more difficult.

### CROSS-REFERENCE TO RELATED APPLICATION

This application claims the benefit of U.S. Provisional Application No. 62/273,499 filed Dec. 31, 2015, entitled “SELF POLYMORPHING EVOLVING CODE TECHNOLOGY ENHANCED RESISTANCE”, which is hereby incorporated by reference in its entirety without giving rise to disavowment.

### TECHNICAL FIELD

The present disclosure relates to information security in general, and to enhanced anti-reverse engineering protection of software resources, in particular.

### BACKGROUND

Computerized devices and systems control many aspects of our daily life, from composing text documents to controlling traffic lights, for example. However, computers are also a target of sabotage, exploitation and otherwise malicious activity, whether in the form of self-executing code intended to disrupt normal operation of computers or corrupt data stored therein, e.g. viruses, worms, or the like, tools for data theft or falsification, such as Trojan horses and backdoors, or likewise threats on proper functioning or information integrity in general.

In recent years, with the advent of computer networks and digital communication, such as, for example, via the Internet or World Wide Web, computers and other network devices are ever more susceptible to security threats, with an imminent and continuously present danger of being the object of an attack or intrusion, also colloquially known as “hacking”. Such attacks can be aimed at either one of computer programs or applications, security protocols, and the like. On some occasions, an attack may be carried out by, or consist of, reverse engineering of any one of these items. In order to hack into secured networks or create false report in a security program, hackers study these programs and how they work. They map their process, extract their code and algorithms and use it for their own purposes. In some cases, by reverse engineering a software, the hackers may utilize the reverse engineered program in a manner which allows them to manipulate the original programs or protocols, exploit or replace them.

In some cases, programmers may attempt to make it harder for a hacker to reverse engineer the program by making the code harder to decrypt and analyze.

Another solution is to attempt and stay ahead of hackers—every time the code is being hacked—a security update is being sent in order to fix the issue.

### BRIEF SUMMARY

One exemplary embodiment of the disclosed subject matter is a computer-implemented method performed by a processor executing a computer program, the computer program comprising an object utilized in processing performed by the computer program and capable of admitting content, the method comprising: receiving an incremental content modification from a server, wherein the incremental content modification is distributed by the server to a plurality of computerized apparatuses capable of executing the computer program, wherein the incremental content modification comprising a modification of a current content of the object, whereby an updated content of the object in each instance of the computer program in the plurality of computerized apparatuses, is obtainable in a synchronized manner and without the updated content being transmitted via a communication channel; updating the current content of the object based on the incremental content modification, whereby the content is updated from the current content to the updated content; and performing the processing based on the updated content of the object, whereby operation of the computer program is altered in comparison to operation thereof prior to said updating; wherein obtaining an instance of the computer program prior to said updating and without having the incremental content modification, or obtaining the incremental content modification without having at least the current content of the object, results in an invalid instance of the computer program operating in a different manner than instances of the computer program in the plurality of computerized apparatuses; whereby an added difficulty on reverse engineering of the computer program is imposed.

Another exemplary embodiment of the disclosed subject matter is a computer-implemented method performed by a processor executing a computer program, the computer program comprising a plurality of code sections, the method comprising: receiving an incremental code modification from a server, wherein the incremental code modification is distributed by the server to a plurality of computerized apparatuses capable of executing the computer program, wherein the incremental code modification comprising a modification to a current composition of the plurality of code sections, whereby an updated composition of the plurality of code sections comprised in each instance of the computer program in the plurality of computerized apparatuses, is obtainable in a synchronized manner and without the updated composition being transmitted via a communication channel; updating the current composition of the plurality of code sections based on the incremental code modification, whereby the plurality of code sections are updated from the current composition to the updated composition; and performing the processing based on the updated composition of the plurality of code sections, whereby operation of the computer program is altered in comparison to operation thereof prior to said updating; wherein obtaining an instance of the computer program prior to said updating and without having the incremental code modification, or obtaining the incremental code modification without having at least the current composition of the plurality of code sections, results in an invalid instance of the computer program operating in a different manner than instances of the computer program in the plurality of computerized apparatuses; whereby an added difficulty on reverse engineering of the computer program is imposed.

Yet another exemplary embodiment of the disclosed subject matter is a computer-implemented method performed by a processor executing a computer program, the computer program comprising a function utilized in processing performed by the computer program, which function being configured for admitting input and generate output therefrom, the method comprising: receiving an incremental algorithmic modification from a server, wherein the incremental algorithmic modification is distributed by the server to a plurality of computerized apparatuses capable of executing the computer program, wherein the incremental algorithmic modification comprising a modification to a current implementation of the function, whereby an updated implementation of the function comprised in each instance of the computer program in the plurality of computerized apparatuses, is obtainable in a synchronized manner and without the updated implementation being transmitted via a communication channel; updating the current implementation of the function based on the incremental algorithmic modification, whereby the function is updated from the current implementation to the updated implementation; and performing the processing based on the updated implementation of the function, whereby an output generated by the function from a given input is altered in comparison to an output generated thereby from the given input prior to said updating; wherein obtaining an instance of the computer program prior to said updating and without having the incremental algorithmic modification, or obtaining the incremental algorithmic modification without having at least the current implementation of the function, results in an invalid instance of the computer program operating in a different manner than instances of the computer program in the plurality of computerized apparatuses; whereby an added difficulty on reverse engineering of the computer program is imposed.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a flowchart diagram of a method, in accordance with some exemplary embodiments of the disclosed subject matter;

FIG. 1B shows a flowchart diagram of a method, in accordance with some exemplary embodiments of the disclosed subject matter;

FIG. 1C shows a flowchart diagram of a method, in accordance with some exemplary embodiments of the disclosed subject matter;

FIG. 2 shows a block diagram of an apparatus comprised in a computerized environment schematically illustrated, in accordance with some exemplary embodiments of the disclosed subject matter; and

FIG. 3 shows a flowchart diagram schematically illustrating operating mode and principles of utilizing the disclosed subject matter to frustrate hacking attempts, in accordance with some exemplary embodiments of the disclosed subject matter.

### DETAILED DESCRIPTION

One technical problem dealt with by the disclosed subject matter is to provide for enhanced protection against reverse engineering of computing platforms, computer programs, network communication protocols, algorithms, or likewise computing resources, reverse engineering thereof is likely to be performed for malicious purposes.

One technical solution is to use an incremental modification technique for updating computer program code or other similar computing resource used thereby for processing, whereby allowing for specific segments of the code to polymorph and evolve in order to prevent reverse code engineering from working effectively. In some exemplary embodiments, instances of the program may be in communication with one another in a secure manner, such as by performing port scrambling during communication, using encrypted communication, or the like. Such secure communication may rely on the instances utilizing a shared algorithm (e.g., for scrambling/descrambling, encrypting/decrypting, or the like). A central server may periodically send random changes to the shared algorithm. The changes may indicate a modification to the algorithm (and not a replacement version). The modification may not be merely semantic or related to control flow but rather may provide for a different computed output. For example, if the algorithm requires a computation of a formula, the formula may be changed by adding a constant value, by subtracting a constant value, by multiplying the value by a constant, by exponentiation of the value by a constant, by dividing or taking a modulus of the formula by a constant, or the like. In some exemplary embodiments, the change may be a random change so as not to be foreseen. Potentially, different instances of the system may create a different version of the algorithm in view of the random changes thereto. In some further exemplary embodiments, the change may be performed periodically within a time period that is considered as too short to allow a hacker to reverse engineer the software during it, such as, for example, at every hour, every four hours, every day, or the like.

One technical effect of utilizing the disclosed subject matter is to prevent from a hacked version of an algorithm from being effectively used, such that, in case that reverse engineering is applied and the algorithm is extracted—it will not work on the protected system—since it is potentially already changed. If an attacker tries to listen and capture the changes in the algorithm, such attacker will only receive the deltas sent to the algorithm, and since the original algorithm the attacker employs is not the shared (modified) algorithm—the attacker will still remain with the wrong algorithm that is incompatible with the other instances in the system.

Another technical problem dealt with by the disclosed subject matter is protecting databases from reverse engineering. It will be appreciated that in order to inject false data or receive data from a database, an assailant needs to know in advance the structure of the database before the attack.

Another technical solution in accordance with the disclosed subject matter is that a central server periodically sends changes to the order, structure and/or name of the fields in a database tables. In some cases, some changes may create or destroy dummy fields in the database tables, change ordering of these fields, names of these fields, or the like. Based on the modification of the database, access commands within the application may also be modified according to the changes made.

Another technical effect of utilizing the disclosed subject matter, similarly as above, is that if a reverse engineering procedure is applied and the database structure is extracted—it will not work on the protected system—since it was changed in the meantime. If an attacker tries to listen and capture the changes in the database, he will only receive the delta in the current structure and not the correct structure—and he will still remain with the wrong access string to the database.

In some exemplary embodiments, the database may be updated periodically to only some of the instances of the software, such as based on geographical location, organizational association, locale information, IP or information of the device executing the instance, demographic information of the user, or the like. Additionally or alternatively, the instances may be sorted into groups and each group may be updated together and independently of the other groups. In some exemplary embodiments, a group may be determined based on a random or a pseudo-random characterization of the instance, such as an id. As a result, successful hacking to one instance of the group may not be useful to exploit or target an instance of another group.

In some exemplary embodiments, the database may be updated based on a determination of the instance itself and without relying on an instruction from a server. In case the instance updates itself independently there may not be a need to a central mechanism for synchronizing the update instructions.

Yet another technical problem dealt with by the disclosed subject matter is to provide a counter measure against reverse engineering of any arbitrary software entity at hand, e.g. an application program.

Yet another technical solution in accordance with the disclosed subject matter is that a central server periodically sends changes to a given structure of various code blocks in the application program. In some exemplary embodiments, one or more keys may be introduced into different locations within the program code, preferably selected at random. Based on randomized deltas given from the server, the one or more keys may change their locations. Additionally or alternatively, the keys themselves may be changed using deltas received from the server. The application program may be configured to check whether the keys embedded therein in the aforesaid manner are valid keys, e.g. by computing a checksum, hash, or likewise function thereof, and comparing the result to a value that may be provided by the server, preferably in an online manner, such as in a challenge-response testing. The check may be performed either continuously or prior to predetermined sections, e.g. read/write operations, sections where confidential data is obtainable, sections where network communication is performed, or the like. In some exemplary embodiments, a key checker function used in performing the check may employ a formula, which may in itself be subjected to periodic updates using delta changes supplied by the server. It will be appreciated that in some exemplary embodiments the application program may have to be subject to a pre-processing step, such as a re-design, code wrapping or decorating, or any likewise code functionality enhancement mechanism, in order to utilize, and benefit from, the disclosed subject matter and additional security layer whereby provided.

Yet another technical effect of utilizing the disclosed subject matter, similarly as above, is that if a reverse engineering or hacking attempt is made and the application program is thereby compromised—a hacked instance of the application program will stop working—since the application program was changed and thus the hacked instance no longer matches it. If an attacker tries to listen and capture the changes, the attacker will only receive the delta in the current structure and not the correct structure—and therefore will not possess the correct verification to the application program for running it properly.

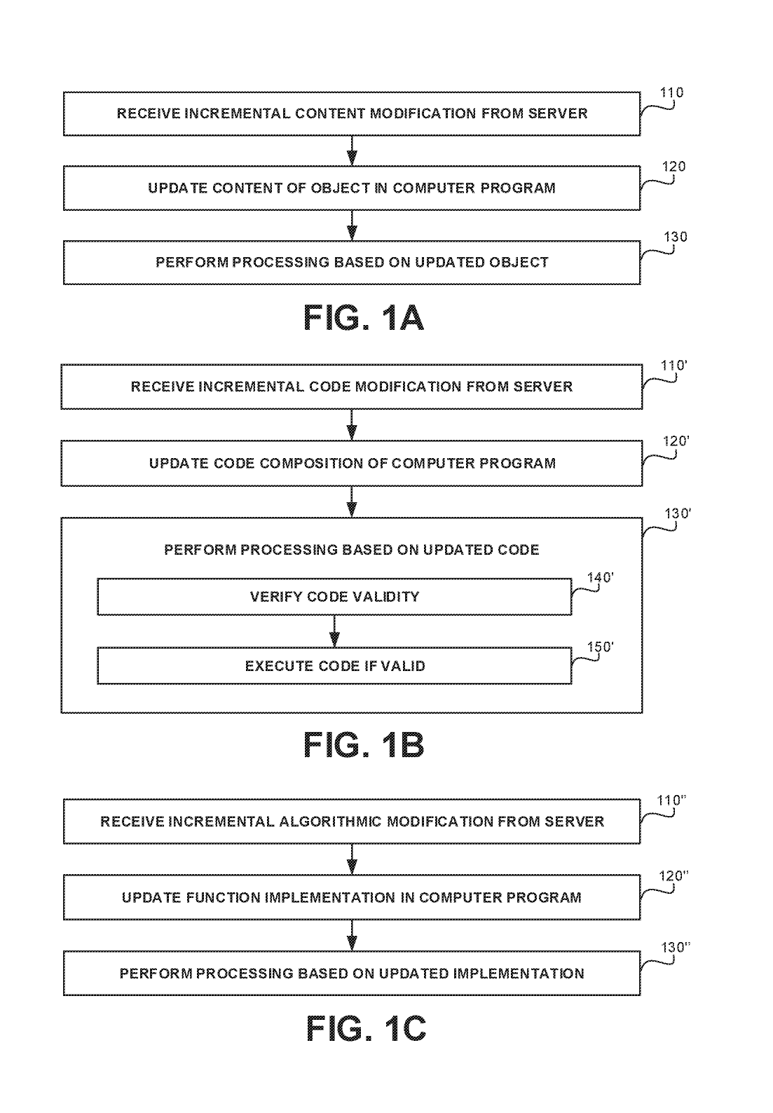

Referring now to FIG. 1A showing a flowchart diagram of a method in accordance with some embodiments of the disclosed subject matter.

On Step 110, an incremental content modification may be received from a server. The incremental content modification may be received at a computerized apparatus being in communication with the server and configured for executing a computer program. The computer program may be retained in a storage device coupled to or comprised by the computerized apparatus. The computer program may be configured for utilizing, in processing performed thereby, an object capable of admitting content. The incremental content modification may comprise a modification to a current content of the object, whereby an updated content thereof may be obtained.

In some exemplary embodiments, the computerized apparatus may be comprised in a network environment of a plurality of computerized apparatuses to which the server distributes the incremental content modification. The server may be configured to transmit incremental content modifications periodically, e.g., monthly, weekly, daily, hourly, or the like. In some exemplary embodiments, the period between each two consecutive incremental content modifications being transmitted, may be rationed so as to make reverse engineering of the computer program during that time practically infeasible or prohibitively intensive on computing resources. The incremental content modifications may be determined by the server using a randomized process. In some exemplary embodiments, the object may be initialized with an initial content assignment provided to an instance of the computer program retained in the computerized apparatus at a first distribution of the computer program to the computerized apparatus or subsequently from the server.

On Step 120, the incremental content modification received on Step 110 may be used for updating content of the object in the computer program, from a current content thereof to an updated content per a modification entailed by the incremental content modification, whereby an updated content of the object is obtained in a synchronized manner and without the updated content being transmitted via a communication channel. It will be appreciated that by transmitting only the incremental content modification, i.e. a delta change between the current content and the updated content, rather than transmitting the updated content itself, a risk of the updated content being intercepted by a man-in-the-middle eavesdropping to the transmission channel is avoided. As a result, a likelihood of the updated content being used to reverse engineer the program for malicious purposes, or otherwise exploited or corrupted, is significantly decreased.

On Step 130, processing may be performed by the computer program based on the updated content of the object as obtained on Step 120. In some exemplary embodiments, operation of the computer program based on the updated content may be altered in comparison to its operation prior to the updating performed on Step 120. In consequence, any instance of the computer program obtained by an unauthorized entity prior to performing of Step 120, such as, for example, by means of hacking to the computerized apparatus, performing reverse engineering of the computer program during its execution on the computerized apparatus, or the like, may become invalid and possibly ineffective for its intended purpose thereafter, unless every incremental content modification is also obtained by that entity. Similarly, if the unauthorized entity manages to intercept the incremental content modification, without having also obtained the computer program with a current content of the object, then the unauthorized entity would still remain with an invalid instance of the computer program after applying the incremental content modification on a hacked copy of the computer program it possesses.

In some exemplary embodiments, the object may be a database. The database may comprise one or more tables, each of which having a plurality of fields. The incremental content modification may comprise a change to the schema of the database, such as, for example, names of fields, ordering of the fields or tables, addition or deletion of dummy fields, or the like. Changes to the database schema may be designed themselves for being applied in an incremental manner, e.g. a change of name may be accomplished by concatenation of a string as a prefix, suffix, or the like to a pre-existing field name, i.e. “user id” may be substituted by “user_id1234” or the like. The manner by which changes are indicated in the incremental content modification may be preferably designed so as not to disclose details of the database schema or current disposition thereof. For example, fields ordering change may be indicated by mere specifying of a permutation over the whole set fields, including all fixed points, if any, without reference to specific fields by name, content, or likewise privileged information. In some exemplary embodiments, SQL injection attacks may be prevented as such attack may require a knowledge of the database schema. Even if an attacker is made aware of the schema, the attacker may not make use of such information, as when the attacker attempts to employ it, the schema may have already changed. Additionally or alternatively, the dummy fields may be fields that are defined as requiring to be set with a value, thereby preventing SQL injection attacks which insert new records by an attacker who is not aware of all the dummy fields.

It will be appreciated, however, that the disclosed subject matter is not meant to be limited in such manner, and may be utilized in context of other software resources incrementally modifiable, such as, for example, computer program code, algorithms, protocols, or the like, as described in detail hereinafter.

Referring now to FIG. 1B showing a flowchart diagram of a method in accordance with some embodiments of the disclosed subject matter.

On Step 110′, an incremental code modification may be received from a server. The incremental code modification may be received at a computerized apparatus being in communication with the server and configured for executing a computer program, similarly as in Step 110 of FIG. 1A. The computer program may be embodied in a form of a plurality of contiguous segments of code lines, which in the context of the present disclosure are being referred to as “code sections”. The incremental code modification may comprise a modification to a current composition of the plurality of code segments, whereby an updated composition thereof may be obtained.

In some exemplary embodiments, the computerized apparatus may be comprised in a network environment of a plurality of computerized apparatuses to which the server distributes the incremental code modification. The server may be configured to transmit incremental code modifications periodically, e.g., monthly, weekly, daily, hourly, or the like. In some exemplary embodiments, the period between each two consecutive incremental code modifications being transmitted, may be rationed so as to make reverse engineering of the computer program during that time practically infeasible or prohibitively intensive on computing resources. The incremental code modifications may be determined by the server using a randomized or pseudo-randomized process.

In some exemplary embodiments, the plurality of code segments may be configured for receiving and maintaining a plurality of keys at different locations therein. The keys may be initially provided to an instance of the computer program retained in the computerized apparatus at a first distribution of the computer program to the computerized apparatus or subsequently from the server. In some exemplary embodiments, the server may further provide for a wrapper or decorator software adapting the computer program to incorporate therein placeholders for the plurality of keys in the plurality of code sections. The plurality of code sections for housing the plurality of keys may be dummy code sections injected by the wrapper software such that functionality of the computer program is not affected thereby. The keys may be provided in a form of numeric values, e.g. big integers such as used in cryptographic computing or the like. The keys may be selected by the server at random from a given bank of admissible values or fabricated using a random or pseudo-random generator function or the like.

On Step 120′, the incremental code modification received on Step 110′ may be used for updating composition of the plurality of code sections in the computer program, from a current composition thereof to an updated composition per a modification entailed by the incremental code modification, whereby an updated composition of the plurality of code sections is obtained in a synchronized manner and without the updated composition being transmitted via a communication channel, similarly as accomplished in Step 120 of FIG. 1A. It will be appreciated that by transmitting only the incremental code modification, i.e. a delta change between the current and updated composition, instead of transmitting the updated composition of the code itself, a risk of the updated code being intercepted by a man-in-the-middle eavesdropping to the transmission channel is avoided. As a result, a likelihood of the updated code being used for malicious purposes is significantly decreased.

On Step 130′, processing may be performed by the computer program based on the updated composition of the plurality of code sections, as obtained on Step 120′, similarly as in Step 130 of FIG. 1A. In some exemplary embodiments, operation of the computer program based on the updated composition may be altered in comparison to its operation prior to the updating performed on Step 120′. In consequence, any instance of the computer program obtained by an unauthorized entity prior to performing of Step 120′, such as, for example, by means of hacking to the computerized apparatus, performing reverse engineering of the computer program during its execution on the computerized apparatus, or the like, may become invalid and possibly ineffective for its intended purpose thereafter, unless every incremental code modification is also obtained by that entity. Similarly, if the unauthorized entity manages to intercept the incremental code modification, without having also obtained the computer program with a current composition of the code, then the unauthorized entity would still remain with an invalid instance of the computer program after applying the incremental code modification on a hacked copy of the computer program it possesses.

In some exemplary embodiments, the processing performed on Step 130′ may comprise performing, On Step 140′, an act of verifying the computer program by checking validity of the plurality of code sections comprised in an instance of the computer program being executed or retained in the computerized apparatus at the time, whereby verifying that the computer program maintains its authenticity and integrity, namely that it originates from a legitimate source and has not been tampered with or otherwise corrupted. A positive result to verification of the computer program's code may be set as a precondition to execution of the computer program or predetermined portions thereof being launched or resumed on Step 150′. In some exemplary embodiments, a verification operation performed on Step 140′ may comprise verifying validity of the plurality of keys embedded in the plurality of code sections. In some further exemplary embodiments, a checker function for performing said verification may be also provided in a similar manner as integrated component within the plurality of code sections. Alternatively, the checker function may reside only at the server side and invoked in an online, dynamic fashion upon demand.

In some exemplary embodiments, the incremental code modification may comprise a change to a structure of the plurality of code sections, such as, for example, a re-ordering thereof, an addition, deletion or modification of dummy code sections, or the like. Additionally or alternatively, the incremental code modification may comprise a change to the plurality of keys, where applicable, such as, for example, a change in locations of keys within the code, a change in the keys' values, or the like. In some exemplary embodiments, the incremental code modification may further comprise a change to a checker function for verifying the plurality of keys, where applicable. It will be appreciated that each of which changes to either the code structure, keys' values or locations, checker function, or the like, may be indicated in the incremental code modification in an incremental manner, such that only the differences between the current and updated composition of the code are prescribed thereby and not the whole composition (current or updated) in entirety. For example, a structure change may be prescribed as an instruction to duplicate a dummy code section in a start position and placing a copy in an end position. Similarly, a key location change may be stated as an instruction to move up or down a specified number of code lines, or to displace to another code section altogether. A change to a key value may be instructed as an arithmetic operation to be performed on a current value, e.g. addition, subtraction, multiplication or division by a specified value or the like. Any and all of such changes may be also fed into a checker function where present so it is updated accordingly.

Referring now to FIG. 1C showing a flowchart diagram of a method in accordance with some embodiments of the disclosed subject matter.

On Step 110″, an incremental algorithmic modification may be received from a server, similarly as in Steps 110 and 110′ of FIGS. 1A-1B. The incremental algorithmic modification may be received at a computerized apparatus being in communication with the server and configured for executing a computer program. The computer program may be retained in a storage device coupled to or comprised by the computerized apparatus. The computer program may be configured for utilizing, in processing performed thereby, a function configured to admitting input and generating output therefrom. The incremental algorithmic modification may comprise a modification to a current implementation of the function, whereby an updated implementation thereof may be obtained.

In some exemplary embodiments, the computerized apparatus may be comprised in a network environment of a plurality of computerized apparatuses to which the server distributes the incremental algorithmic modification. The server may be configured to transmit incremental algorithmic modifications periodically, e.g., monthly, weekly, daily, hourly, or the like. In some exemplary embodiments, the period between each two, consecutive incremental algorithmic modifications being transmitted, may be rationed so as to make reverse engineering of the computer program during that time practically infeasible or prohibitively intensive on computing resources. The incremental algorithmic modifications may be determined by the server using a randomized process.

On Step 120″, the incremental algorithmic modification received on Step 110″ may be used for updating implementation of the function in the computer program, from a current implementation thereof to an updated implementation per a modification entailed by the incremental algorithmic modification, whereby an updated implementation of the function is obtained in a synchronized manner and without the updated implementation being transmitted via a communication channel, similarly as in Steps 120 and 120′ of FIGS. 1A-1B. It will be appreciated that by transmitting only the incremental algorithmic modification, i.e. a delta change between the current implementation and the updated implementation, rather than transmitting the updated implementation itself, a risk of the updated implementation being intercepted by a man-in-the-middle eavesdropping to the transmission channel is avoided. As a result, a likelihood of the updated implementation being used to reverse engineer the program for malicious purposes is significantly decreased.

On Step 130″, processing may be performed by the computer program based on the updated implementation of the function as obtained on Step 120″, similarly as in Steps 130 and 130′ of FIGS. 1A-1B. In some exemplary embodiments, operation of the computer program based on the updated implementation may be altered in comparison to its operation prior to the updating performed on Step 120″. In consequence, any instance of the computer program obtained by an unauthorized entity prior to performing of Step 120″, such as, for example, by means of hacking to the computerized apparatus, performing reverse engineering of the computer program during its execution on the computerized apparatus, or the like, may become invalid and possibly ineffective for its intended purpose thereafter, unless every incremental algorithmic modification is also obtained by that entity. Similarly, if the unauthorized entity manages to intercept the incremental algorithmic modification, without having also obtained the computer program with a current implementation of the function, then the unauthorized entity would still remain with an invalid instance of the computer program after applying the incremental algorithmic modification on a hacked copy of the computer program it possesses.

In some exemplary embodiments, the incremental algorithmic modification received on Step 110″ may comprise an indication of a second function, similarly configured for admitting input and generate output therefrom. The second function may be configured for admitting one or more types of input, a first of which conforming in type to output generated by the function, and zero or more additional input parameters as a second type of input, which input parameters or values therefor may also be indicated in the incremental algorithmic modification. The updated implementation may accordingly be obtained by composing the second function on the function, along with the zero or more input parameters values, where applicable. In some further exemplary embodiments, the function may be an arithmetic formula adapted to admitting a sequence of one or more variables and generate a single value therefrom. The second function may be an arithmetic operator over one or more operands, a first of which being an output of the function, and the remainder zero or more operands being some arbitrary values, which may be prescribed in the incremental algorithmic modification or otherwise determined in a centralized manner. For example, the operator may be an addition, subtraction, multiplication, division, exponentiation or the like of an output of the function by a constant value, e.g. “+5”, “*2”, “−3”, or the like. In some exemplary embodiments, the values of the additional zero or more operands of the operator may be selected by the server at random or obtained using random or pseudo-random number generation algorithms, such as used in cryptographic computing or the like.

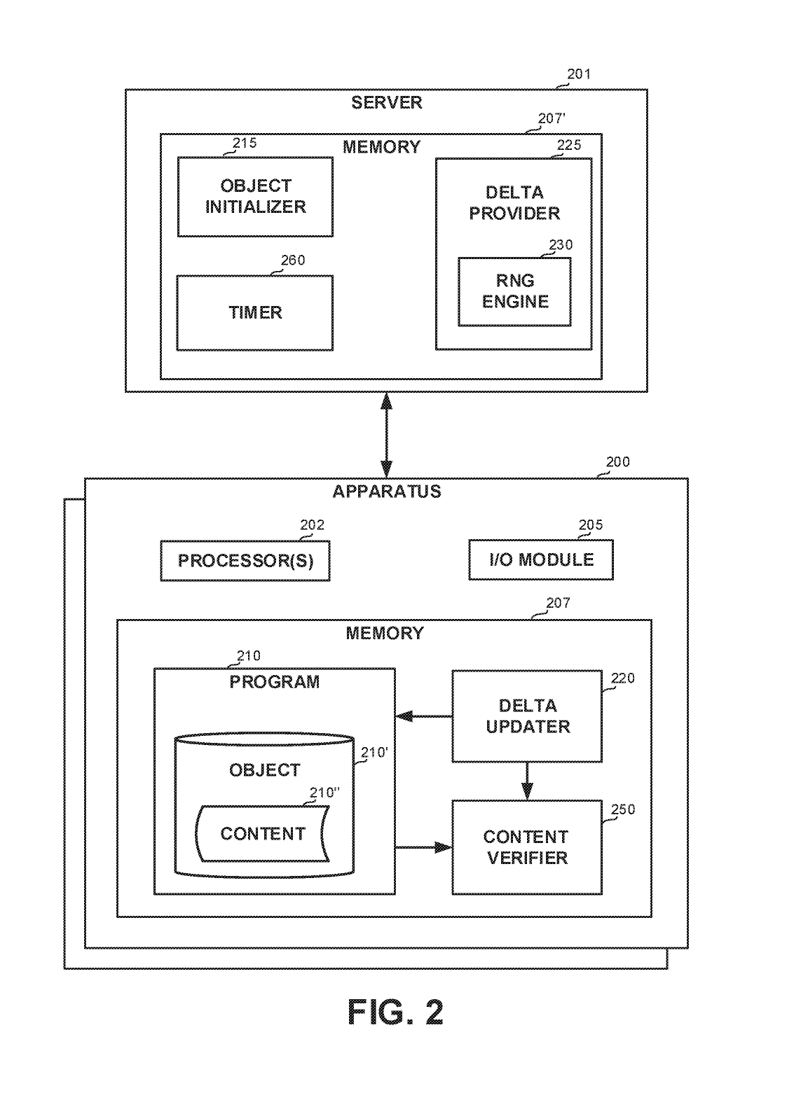

Referring now to FIG. 2 showing a block diagram of an apparatus comprised in a computerized environment schematically illustrated, in accordance with some exemplary embodiments of the disclosed subject matter. An Apparatus 200 may be configured to provide for an enhanced resistance to reverse engineering of a computer program or other software resource executing thereon, in accordance with the disclosed subject matter.

In some exemplary embodiments, Apparatus 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Apparatus 200 or any of it subcomponents.

In some exemplary embodiments of the disclosed subject matter, Apparatus 200 may comprise an Input/Output (I/O) Module 205. I/O Module 205 may be utilized to provide an output to and receive input from a user or another apparatus being in communication therewith, such as Server 201. Server 201 may comprise, similarly to Apparatus 200, a Processor (not shown), an I/O Module (not shown), and a Memory 207′. Apparatus 200 may communicate with Server 201 over any available communication channel, such as the Internet.

In some exemplary embodiments, Apparatus 200 may comprise a Memory 207. Memory 207 may be a hard disk drive, a Flash disk, a Random Access Memory (RAM), a memory chip, or the like. In some exemplary embodiments, Memory 207 may retain program code operative to cause Processor 202 to perform acts associated with any of the subcomponents of Apparatus 200.

Apparatus 200 may be configured to execute a Program 210 retained in Memory 207, which may comprise a sequence of instructions to be performed by Processor 202. Program 210 may comprise an Object 210′ to be utilized in processing performed by Program 210 during execution thereof on Apparatus 200. Object 210′ may be any computing resource, such as, for example, a database, an algorithm, a library, a code block, or the like. In some exemplary embodiments, Object 210′ may be configured for receiving and maintaining a Content 210″. For example, Content 210″ may be a database schema comprised of tables having data fields of predetermined names, structure and ordering, where Object 210′ is a database. As another example, Content 210″ may be a composition of code segments of Program 210 comprising structure, ordering, values or locations of keys, or the like. It will be noted that Program 210 may be executed by many different Apparatuses 200 each of which communicating with Server 201.

Memory 207 may comprise a Delta Updater 220, configured for updating Content 210″ of Object 210′ in Program 210 based on an incremental modification thereto as received from Server 201, similarly as in Steps 120, 120′ and 120″ of FIGS. 1A-1C. In some exemplary embodiments, Memory 207 may further comprise a Content Verifier 250, configured for verifying validity of Content 210″, similarly as in Step 150′ of FIG. 1B. Content Verifier 250 may be either integrally comprised by Program 210 or provided as stand-alone unit capable of interfacing therewith. In some exemplary embodiments, Delta Updater 220 may be further configured to update Content Verifier 250 too using an appropriate incremental modification received from Server 201, whether as part of the modification to Content 210″ or in addition thereto. Additionally or alternatively, Content Verifier 250 may verify content received from another instance of Program 210, such as another copy of Program 210 being executed on another apparatus. Additionally or alternatively, Server 201 may comprise Content Verifier 250, which may be used to verify content transmitted to Server 201 by Apparatus 200, so as to ensure Apparatus 200 is executing a non-compromised version of Program 210. As an example, Object 210′ may be used to generate a certificate used to encrypt data or shuffle ports to be used in communication. Content Verifier 250 may be located on another device (e.g., another apparatus or Server 201) and use the corresponding object to generate a corresponding certificate. In the absence of a difference between the two certificates, the data may be decrypted or the ports may be unshuffled correctly, thereby the content of Object 210′ is verified.

In some exemplary embodiments, Server 201 may comprise an Object Initializer 215 configured for providing an initial content assignment distributed to Apparatus 200, whereby Object 210′ is initialized with initial Content 210″. In some further exemplary embodiments, Object Initializer 215 may be further configured for providing a wrapper function to enhance Program 210 with evolving code polymorphing capabilities, such as, for example, receiving, maintaining and verifying keys at specific locations in the program code, in accordance with the disclosed subject matter.

Server 201 may comprise a Delta Provider 225 configured for providing incremental modifications of Content 210″ to Apparatus 200. In some exemplary embodiments, the incremental modifications may be randomized. Delta Provider 225 may comprise a Random Number Generator (RNG) Engine 230 to assist in random or pseudo random computing functions that may be required in connection with provision of incremental modifications by Delta Provider 225. Server 201 may provide the incremental modifications periodically. In some exemplary embodiments, Server 201 may comprise a Timer 260 configured for timing a period between issuing of one incremental modification by Server 201 and until a next incremental modification succeeding it is delivered.

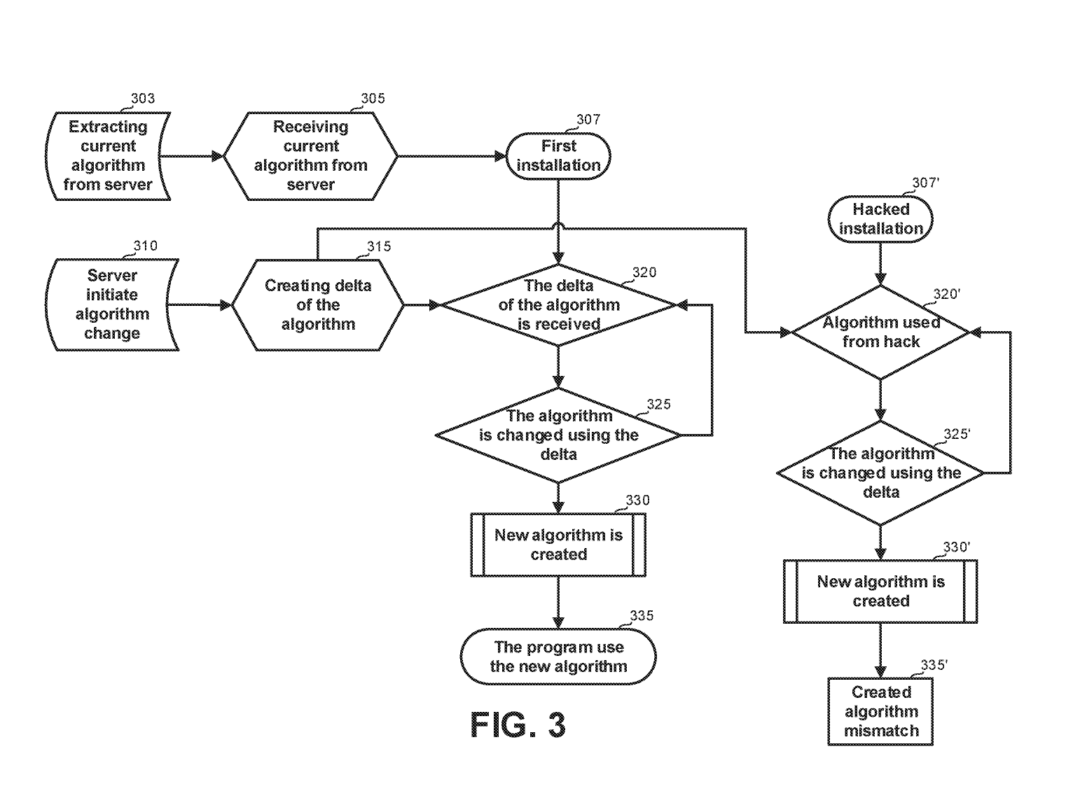

Referring now to FIG. 3 showing a flowchart diagram schematically illustrating operating mode and principles of utilizing the disclosed subject matter to frustrate hacking attempts, in accordance with some exemplary embodiments of the disclosed subject matter.

A current algorithm version may be extracted from the server in Step 303, received at an authorized apparatus in Step 305, and first installed thereon in Step 307. A hacked installation may then be obtained by an unauthorized entity in Step 307′, such as by reverse engineering of first installation performed in Step 307. An algorithm change may be initiated by the server in Step 310, and a delta of the algorithm may be accordingly created in Step 315. The delta of the algorithm may be received at the authorized apparatus in Step 320 and used to change the algorithm accordingly in Step 325. Steps 320 to 325 may be repeated one or more times, in accordance with algorithm changes as initiated by the server. Based on the accumulated changes thereto, a new algorithm may be created in Step 330 and used by the program in Step 335. The unauthorized entity may attempt to imitate the process and use the algorithm from the hacked installation in Step 320′, which algorithm may then also be changed in Step 325′ using the delta, similarly as in Step 325, and, following one or more such changes, a new algorithm may be created based thereon in Step 330′. However, as the unauthorized entity may not have access to the first installation of the algorithm, but rather to merely a hacked installation at best, or it may not have access to one or more of the deltas, then the created algorithm of Step 330′ may end up in Step 335′ being in mismatch with the algorithm used by the program in Step 335.

The disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A computer-implemented method performed by a processor executing a computer program, the computer program comprising an object utilized in processing performed by the computer program and capable of admitting content, the method comprising:
receiving an incremental content modification from a server, wherein the incremental content modification is distributed by the server to a plurality of computerized apparatuses capable of executing the computer program, wherein the incremental content modification comprising a modification of a current content of the object, whereby an updated content of the object in each instance of the computer program in the plurality of computerized apparatuses, is obtainable in a synchronized manner and without the updated content being transmitted via a communication channel;
updating the current content of the object based on the incremental content modification, whereby the content is updated from the current content to the updated content; and
performing the processing based on the updated content of the object, whereby operation of the computer program is altered in comparison to operation thereof prior to said updating;
wherein obtaining an instance of the computer program prior to said updating and without having the incremental content modification, or obtaining the incremental content modification without having at least the current content of the object, results in an invalid instance of the computer program operating in a different manner than instances of the computer program in the plurality of computerized apparatuses;
whereby an added difficulty on reverse engineering of the computer program is imposed.

2. The computer-implemented method of claim 1, wherein the incremental content modification is determined based on a random variable.

3. The computer-implemented method of claim 1, wherein incremental content modifications are sent by the server periodically.

4. The computer-implemented method of claim 1, wherein the object is a database comprising at least one table having a plurality of fields, wherein the incremental content modification comprising a change to at least one schematic feature of the database selected from the group consisting of: a name of a field in a table of the at least one table; an ordering of two or more fields in a table of the at least one table; an addition of one or more dummy fields to a table of the at least one table; a deletion of one or more dummy fields pre-existing in a table of the at least one table; and any combination thereof.

5. A computer program product comprising a computer readable storage medium retaining instructions of a computer program, the computer program comprising an object utilized in processing performed by the computer program and capable of admitting content, wherein the instructions when read by a processor, cause the processor to perform the method of claim 1.

6. A computerized apparatus having a processor and memory, wherein the memory comprising a computer program product, wherein the computer program product comprising a computer readable storage medium retaining instructions of a computer program, the computer program comprising an object utilized in processing performed by the computer program and capable of admitting content, wherein the instructions when read by a processor, cause the processor to perform the method of claim 1.

7. A computer-implemented method performed by a processor executing a computer program, the computer program comprising a plurality of code sections, the method comprising:
receiving an incremental code modification from a server, wherein the incremental code modification is distributed by the server to a plurality of computerized apparatuses capable of executing the computer program, wherein the incremental code modification comprising a modification to a current composition of the plurality of code sections, whereby an updated composition of the plurality of code sections comprised in each instance of the computer program in the plurality of computerized apparatuses, is obtainable in a synchronized manner and without the updated composition being transmitted via a communication channel;
updating the current composition of the plurality of code sections based on the incremental code modification, whereby the plurality of code sections are updated from the current composition to the updated composition; and
performing the processing based on the updated composition of the plurality of code sections, whereby operation of the computer program is altered in comparison to operation thereof prior to said updating;
wherein obtaining an instance of the computer program prior to said updating and without having the incremental code modification, or obtaining the incremental code modification without having at least the current composition of the plurality of code sections, results in an invalid instance of the computer program operating in a different manner than instances of the computer program in the plurality of computerized apparatuses;
whereby an added difficulty on reverse engineering of the computer program is imposed.

8. The computer-implemented method of claim 7, wherein the modification comprising a change to a structure of the plurality of code sections selected from the group consisting of: an ordering of the plurality of code sections; an addition of one or more dummy code sections; a deletion of one or more dummy code sections pre-existing in the computer program; and any combination thereof.

9. The computer-implemented method of claim 7, wherein the plurality of code sections are configured for embedding therein a plurality of keys distributed by the server, wherein the computer program is configured to perform verification of the plurality of keys, wherein execution of at least a portion of the computer program is conditioned on a positive result of verification of the plurality of keys.

10. The computer-implemented method of claim 9, wherein the modification comprising a change to at least one of: a location of one or more keys within the plurality of code sections; a value of one or more keys.

11. The computer-implemented method of claim 9, wherein verification of the plurality of keys is performed using a checker function, wherein the modification comprising a change to the checker function.

12. The computer-implemented method of claim 7, wherein the incremental code modification is determined based on a random variable.

13. The computer-implemented method of claim 7, wherein incremental code modifications are sent by the server periodically.

14. A computer-implemented method performed by a processor executing a computer program, the computer program comprising a function utilized in processing performed by the computer program, which function being configured for admitting input and generate output therefrom, the method comprising:
receiving an incremental algorithmic modification from a server, wherein the incremental algorithmic modification is distributed by the server to a plurality of computerized apparatuses capable of executing the computer program, wherein the incremental algorithmic modification comprising a modification to a current implementation of the function, whereby an updated implementation of the function comprised in each instance of the computer program in the plurality of computerized apparatuses, is obtainable in a synchronized manner and without the updated implementation being transmitted via a communication channel;
updating the current implementation of the function based on the incremental algorithmic modification, whereby the function is updated from the current implementation to the updated implementation; and
performing the processing based on the updated implementation of the function, whereby an output generated by the function from a given input is altered in comparison to an output generated thereby from the given input prior to said updating;
wherein obtaining an instance of the computer program prior to said updating and without having the incremental algorithmic modification, or obtaining the incremental algorithmic modification without having at least the current implementation of the function, results in an invalid instance of the computer program operating in a different manner than instances of the computer program in the plurality of computerized apparatuses;
whereby an added difficulty on reverse engineering of the computer program is imposed.

15. The computer-implemented method of claim 14, wherein the incremental algorithmic modification comprising an indication of a second function configured for admitting input and generate output therefrom, which second function being configured for admitting input conforming in type to output generated by the function as a first type of input, wherein the updated implementation is obtained by composing the second function on the function.

16. The computer-implemented method of claim 15, wherein the second function is further configured for admitting zero or more input parameters as a second type of input, wherein the incremental algorithmic modification further comprising an indication of values for the zero or more input parameters.

17. The computer-implemented method of claim 16, wherein the function is an arithmetic formula admitting a sequence of one or more variables, wherein the second function is an arithmetic n-ary operator for n greater than or equal to 1, wherein the indication further comprising n−1 numeric values as input parameters.

18. The computer-implemented method of claim 14, wherein the incremental algorithmic modification is determined based on a random variable.

19. The computer-implemented method of claim 14, wherein incremental algorithmic modifications are sent by the server periodically.
